(19) United States
(12) Patent Application Publication
(10) Pub. No.: US 2025/0045565 A1
(43) Pub. Date: Feb. 6, 2025

(54) Multi-Modality Aware Transformer

(71) Applicant: International Business Machines Corporation, Armonk, NY (US)

(72) Inventors: Hajar Emami Gohari, Dallas, TX (US); Xuan-Hong Dang, Yorktown Heights, NY (US); Syed Yousaf Shah, Yorktown Heights, NY (US); Vadim Sheinin, Yorktown Heights, NY (US); Petros Zerfos, Yorktown Heights, NY (US)

(73) Assignee: International Business Machines Corporation, Armonk, NY (US)

(21) Appl. No.: 18/228,415

(22) Filed: Jul. 31, 2023

(51) Int. Cl. G06N 3/0455

(52) U.S. Cl. CPC G06N 3/0455

(57) ABSTRACT

A system, computer program product, and method are provided for leveraging artificial intelligence (AI) directed at time-series forecasting. An AI transformer model is configured to support multiple modality datasets for predicting a target time-series together with an explanation through one or more neural attention mechanisms. The multiple modality transformer model exploits intermodal interactions from a first dataset having a first modality, in addition to multi-modality interactions between the first dataset and a second dataset having a second modality different from the first modality.

### BACKGROUND

The present invention relates to an artificial intelligence neural architecture transformer, and more specifically, to a transformer configured to manage multiple data modalities and generate prediction data as output.

### SUMMARY

The embodiments include a system, a computer program product, and a method for time-series forecasting via a multiple modality aware artificial intelligence neural network transformer. This Summary is provided to introduce a selection of representative concepts in a simplified form that is further described below in the Detailed Description. This Summary is not intended to identify key features or essential features of the claimed subject matter, nor is it intended to be used in any way that would limit the scope of the claimed subject matter.

Accordingly to an embodiment, a computer-implemented method is provided for interfacing with an artificial intelligence transformer model configured with an encoder and a decoder, and having been trained on first and second datasets comprising different first and second modalities, respectively. The method includes inputting target series data into the transformer. The second dataset comprises time series data. The encoder, which comprises separate first and second modality streams is configured for analyzing the first and the second datasets, respectively, and each of the first and second modality streams respectively, performing feature-level attention, intra-modal multi-head attention, and inter-modal multi-head attention. The encoder produces an output using the feature-level attention, the intra-modal multi-head attention, and the inter-modal multi-head attention and sends the output to the decoder. In response to the inputting, an inferred variable related to the target series data is received from the transformer.

According to another embodiment, a computer program product is provided with a computer readable storage medium or media, and program code executable by a processor. The program code is configured to input target series data into a transformer comprising an encoder and a decoder, the transformer having been trained on first and second datasets comprising different first and second modalities, respectively. The second dataset comprising time series data. The encoder, comprising separate first and second modality streams, includes program code for analyzing the first and the second datasets, respectively, and each of the first and second modality streams respectively, performing feature-level attention, intra-modal multi-head attention, and inter-modal multi-head attention. The encoder producing an output using the feature-level attention, the intra-modal multi-head attention, and the inter-modal multi-head attention, and sending the output to the decoder. In response to the input, the program code is configured to receive from the transformer an inferred variable related to the target series data.

According to yet another embodiment, a computer system is provided a processor operatively coupled to memory. An artificial intelligence (AI) platform is provided and operatively coupled to the processor. The AI platform comprises a transformer having an encoder and a decoder, and having been trained on first and second datasets comprising different first and second modalities, respectively. The AI platform further comprises one or more tools configured to interface with the transformer, with the interfacing including input target series data into the transformer. The second dataset comprises time series data. The encoder, which comprises separate first and second modality streams and is configured to analyze the first and the second datasets, respectively, and each of the first and second modality streams respectively, is configured to perform feature-level attention, intra-modal multi-head attention, and inter-modal multi-head attention. The encoder is further configured to produce an output using the feature-level attention, the intra-modal multi-head attention, and the inter-modal multi-head attention and send the output to the decoder. In response to the input, an inferred variable related to the target series data is configured to be received from the transformer.

These and other features and advantages will become apparent from the following detailed description of the present exemplary embodiment(s), taken in conjunction with the accompanying drawings.

### BRIEF DESCRIPTION OF THE DRAWINGS

The drawings referenced herein form a part of the specification and are incorporated herein by reference. Features shown in the drawings are meant as illustrative of only some embodiments, and not of all embodiments, unless otherwise explicitly indicated.

FIG. 1 depicts a computing environment for the execution of at least some of the computer code involved in performing the inventive methods, such as time-series forecasting via a multiple modality aware artificial neural network transformer.

FIG. 2 depicts a block diagram to illustrate a general representation of application of the transformer to multiple modalities.

FIG. 3 depicts a block diagram to illustrate an artificial intelligence neural network transformer that incorporates multiple data sources from different modalities, hereinafter referred to as a multi-modal transformer.

FIG. 4A depicts a block diagram to illustrate an example of identified features for the textual input, and FIG. 4B depicts a block diagram to illustrate an example of identified features for the time-series input.

FIG. 5A depicts a block diagram to illustrate an abstract generation of the intra-modal attention vector, Attnₜₓₜ^{intra}, for the text based modality, FIG. 5B depicts a block diagram to illustrate an abstract generation of the intra-modal attention vector, Attnₜₛ^{intra}, for the time-series based modality, and FIG. 5C depicts a block diagram to illustrate an abstract generation of the inter-modal attention vector, Attnₜₓₜ^{inter}.

FIG. 6A depicts a block diagram to illustrate an abstraction of the target cross attention vector for textual data, and FIG. 6B depicts a block diagram to illustrate an abstraction of the target cross attention vector for time-series data.

FIG. 7 depicts a block diagram to illustrate a feature level attention layer of the multi-modal transformer as applied to a textual input sequence and the creation of associated output vectors.

### DETAILED DESCRIPTION

It will be readily understood that the components of the present embodiments, as generally described and illustrated in the Figures herein, may be arranged and designed in a wide variety of different configurations. Thus, the following detailed description of the exemplary embodiments of the apparatus, system, method, and computer program product, as presented in the Figures, is not intended to limit the scope of the embodiments, as claimed, but is merely representative of selected embodiments.

Reference throughout this specification to “a select embodiment,” “one embodiment,” “an exemplary embodiment,” or “an embodiment” means that a particular feature, structure, or characteristic described in connection with the embodiment is included in at least one embodiment. Thus, appearances of the phrases “a select embodiment,” “in one embodiment,” “in an exemplary embodiment,” or “in an embodiment” in various places throughout this specification are not necessarily referring to the same embodiment. The embodiments described herein may be combined with one another and modified to include features of one another. Furthermore, the described features, structures, or characteristics of the various embodiments may be combined and modified in any suitable manner.

The illustrated embodiments will be best understood by reference to the drawings, wherein like parts are designated by like numerals throughout. The following description is intended only by way of example, and simply illustrates certain selected embodiments of devices, systems, products, and processes that are consistent with the embodiments as claimed herein.

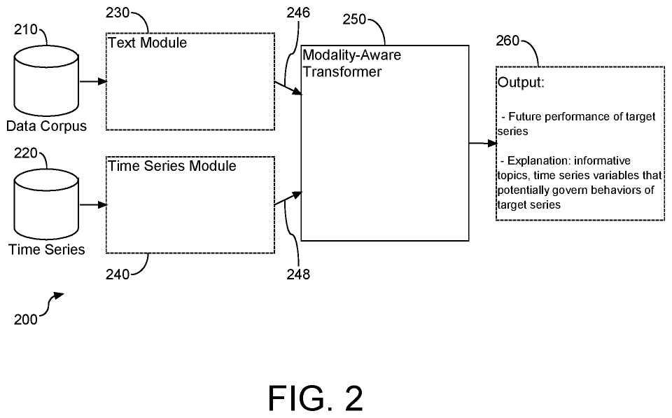

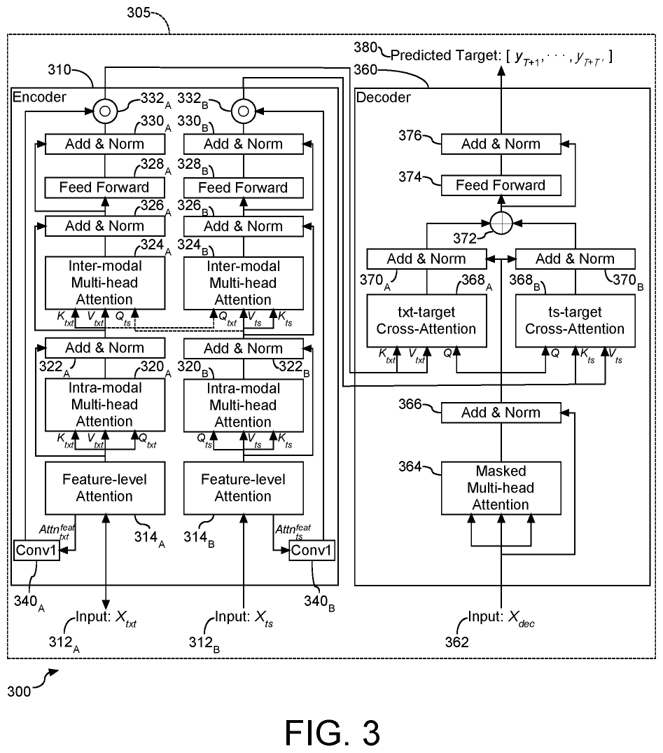

Incorporating multiple data sources under different data formats, such as a time-series format, and extracting useful signals related to the time-series would be helpful to achieve success for a time-series forecasting model. As shown and described herein, a modality-aware transformer based model, hereinafter referred to as a transformer, is configured for utilizing multiple data modalities for predicting a target time-series along with an explanation, through its neural attention mechanism(s), e.g. layers. As shown and described below in FIGS. 2 and 3, the modality-aware transformer receives data from two separate encoding streams, and extracts information in each of the modalities. In an exemplary embodiment, one of the encoding streams is textual data from which the modality-aware transformer extracts text information, and one of the encoding streams is time-series data from which the transformer extracts time-series data. Temporal attentions are generated by applying multi-head attention modules, e.g. layers, in each modality stream. The separation of the modality streams enable the modality-aware transformer to attend to the most informative time steps of the time-series data in each modality. The multi-modality aware transformer also is able to be trained with a reduced and/or accelerated training time because the transformer allows for parallel processing of the sequence. Moreover, the multi-modality aware transformer is better suited for tasks that require capturing long-range dependencies and more complex relationships in a sequence.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

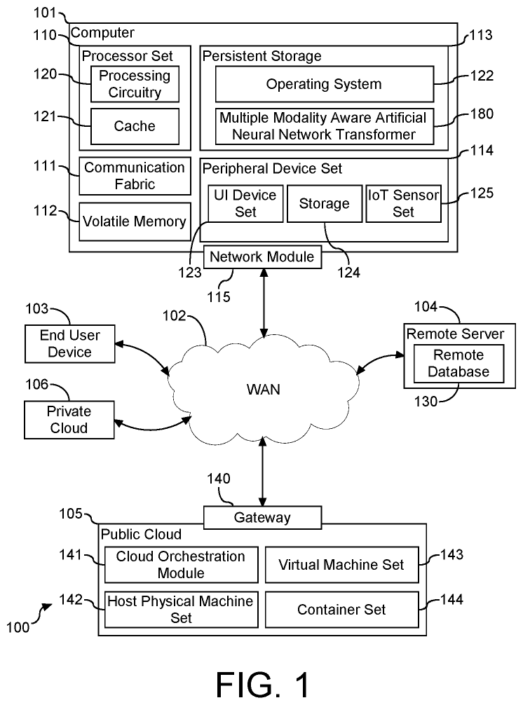

With reference to FIG. 1, computing environment (100) contains an example of an environment for the execution of at least some of the computer code involved in performing the inventive methods, such as time-series forecasting via a multiple modality aware artificial neural network transformer (180), hereinafter referred to as a modality-aware transformer. In addition to block (180), computing environment (100) includes, for example, computer (101), wide area network (WAN) (102), end user device (EUD) (103), remote server (104), public cloud (105), and private cloud (106). In this embodiment, computer (101) includes processor set (110) (including processing circuitry (120) and cache (121)), communication fabric (111), volatile memory (112), persistent storage (113) (including operating system (122) and block (180), as identified above), peripheral device set (114) (including user interface (UI) device set (123), storage (124), and Internet of Things (IoT) sensor set (125)), and network module (115). Remote server (104) includes remote database (130). Public cloud (105) includes gateway (140), cloud orchestration module (141), host physical machine set (142), virtual machine set (143), and container set (144).

Computer (101) may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database (130). As is well understood in the art of computer technology, and depending upon the technology, performance of a computer-implemented method may be distributed among multiple computers and/or between multiple locations. On the other hand, in this presentation of computing environment (100), detailed discussion is focused on a single computer, specifically computer (101), to keep the presentation as simple as possible. Computer (101) may be located in a cloud, even though it is not shown in a cloud in FIG. 1. On the other hand, computer (101) is not required to be in a cloud except to any extent as may be affirmatively indicated.

Processor set (110) includes one, or more, computer processors of any type now known or to be developed in the future. Processing circuitry (120) may be distributed over multiple packages, for example, multiple, coordinated integrated circuit chips. Processing circuitry (120) may implement multiple processor threads and/or multiple processor cores. Cache 121 is memory that is located in the processor chip package(s) and is typically used for data or code that should be available for rapid access by the threads or cores running on processor set (110). Cache memories are typically organized into multiple levels depending upon relative proximity to the processing circuitry. Alternatively, some, or all, of the cache for the processor set may be located “off chip.” In some computing environments, processor set (110) may be designed for working with qubits and performing quantum computing.

Computer readable program instructions are typically loaded onto computer (101) to cause a series of operational steps to be performed by processor set (110) of computer (101) and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache (121) and the other storage media discussed below. The program instructions, and associated data, are accessed by processor set (110) to control and direct performance of the inventive methods. In computing environment (100), at least some of the instructions for performing the inventive methods may be stored in block (180) in persistent storage (113).

Communication fabric (111) is the signal conduction path that allows the various components of computer (101) to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory (112) is any type of volatile memory now known or to be developed in the future. Examples include dynamic type random access memory (RAM) or static type RAM. Typically, volatile memory (112) is characterized by random access, but this is not required unless affirmatively indicated. In computer (101), the volatile memory (112) is located in a single package and is internal to computer (101), but, alternatively or additionally, the volatile memory may be distributed over multiple packages and/or located externally with respect to computer (101).

Persistent storage (113) is any form of non-volatile storage for computers that is now known or to be developed in the future. The non-volatility of this storage means that the stored data is maintained regardless of whether power is being supplied to computer (101) and/or directly to persistent storage (113). Persistent storage (113) may be a read only memory (ROM), but typically at least a portion of the persistent storage allows writing of data, deletion of data and re-writing of data. Some familiar forms of persistent storage include magnetic disks and solid state storage devices. Operating system (122) may take several forms, such as various known proprietary operating systems or open source Portable Operating System Interface-type operating systems that employ a kernel. The code included in block (180) typically includes at least some of the computer code involved in performing the inventive methods.

Peripheral device set (114) includes the set of peripheral devices of computer (101). Data communication connections between the peripheral devices and the other components of computer (101) may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set (123) may include components such as a display screen, speaker, microphone, wearable devices (such as goggles and smart watches), keyboard, mouse, printer, touchpad, game controllers, and haptic devices. Storage (124) is external storage, such as an external hard drive, or insertable storage, such as an SD card. Storage (124) may be persistent and/or volatile. In some embodiments, storage (124) may take the form of a quantum computing storage device for storing data in the form of qubits. In embodiments where computer (101) is required to have a large amount of storage (for example, where computer (101) locally stores and manages a large database) then this storage may be provided by peripheral storage devices designed for storing very large amounts of data, such as a storage area network (SAN) that is shared by multiple, geographically distributed computers. IoT sensor set (125) is made up of sensors that can be used in Internet of Things applications. For example, one sensor may be a thermometer and another sensor may be a motion detector.

Network module (115) is the collection of computer software, hardware, and firmware that allows computer (101) to communicate with other computers through WAN (102). Network module (115) may include hardware, such as modems or Wi-Fi signal transceivers, software for packetizing and/or de-packetizing data for communication network transmission, and/or web browser software for communicating data over the internet. In some embodiments, network control functions and network forwarding functions of network module (115) are performed on the same physical hardware device. In other embodiments (for example, embodiments that utilize software-defined networking (SDN)), the control functions and the forwarding functions of network module (115) are performed on physically separate devices, such that the control functions manage several different network hardware devices. Computer readable program instructions for performing the inventive methods can typically be downloaded to computer 101 from an external computer or external storage device through a network adapter card or network interface included in network module (115).

WAN (102) is any wide area network (for example, the internet) capable of communicating computer data over non-local distances by any technology for communicating computer data, now known or to be developed in the future. In some embodiments, the WAN (102) may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) (103) is any computer system that is used and controlled by an end user (for example, a customer of an enterprise that operates computer (101)), and may take any of the forms discussed above in connection with computer (101). EUD (103) typically receives helpful and useful data from the operations of computer (101). For example, in a hypothetical case where computer (101) is designed to provide a recommendation to an end user, this recommendation would typically be communicated from network module (115) of computer (101) through WAN (102) to EUD (103). In this way, EUD (103) can display, or otherwise present, the recommendation to an end user. In some embodiments, EUD (103) may be a client device, such as thin client, heavy client, mainframe computer, desktop computer and so on.

Remote server (104) is any computer system that serves at least some data and/or functionality to computer (101). Remote server (104) may be controlled and used by the same entity that operates computer (101). Remote server (104) represents the machine(s) that collect and store helpful and useful data for use by other computers, such as computer (101). For example, in a hypothetical case where computer (101) is designed and programmed to provide a recommendation based on historical data, then this historical data may be provided to computer (101) from remote database (130) of remote server (104).

Public cloud (105) is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud (105) is performed by the computer hardware and/or software of cloud orchestration module (141). The computing resources provided by public cloud (105) are typically implemented by virtual computing environments that run on various computers making up the computers of host physical machine set (142), which is the universe of physical computers in and/or available to public cloud (105). The virtual computing environments (VCEs) typically take the form of virtual machines from virtual machine set (143) and/or containers from container set (144). It is understood that these VCEs may be stored as images and may be transferred among and between the various physical machine hosts, either as images or after instantiation of the VCE. Cloud orchestration module (141) manages the transfer and storage of images, deploys new instantiations of VCEs and manages active instantiations of VCE deployments. Gateway (140) is the collection of computer software, hardware, and firmware that allows public cloud (105) to communicate through WAN (102).

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud (106) is similar to public cloud (105), except that the computing resources are only available for use by a single enterprise. While private cloud (106) is depicted as being in communication with WAN (102), in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud (105) and private cloud (106) are both part of a larger hybrid cloud.

Incorporating multiple data sources, under different data formats, and extracting useful signals related to the time-series is helpful to achieve success of a time-series forecasting model. A transformer based neural network model, hereinafter referred to as a modality-aware transformer, is provided and configured to effectively utilize multiple data modalities for predicting a target time-series along with an explanation as output data. As shown and described herein, the modality-aware transformer is configured to extract information from two separate encoding streams, such as a text modality and a time-series modality for extracting information. In some embodiments in a pre-processing step, text articles are gleaned, e.g., automatically, from the internet to produce the text data, e.g., time-stamped text data, to use as a first dataset of training data for the multi-modality aware transformer. By using multiple datasets for training with different modalities, dependency of performance of a first type of data on external factors that are captured or indicated in the second type of data helps achieve enhanced and more accurate inference.

Text information is one potential resource that often carries signals helping to predict future behaviors of some time-series. Examples can be found in the financial domain where large amounts of textual and numerical time-series data are produced that can be potentially used to predict the future of various financial time-series data. For example, statements release by a banking institution often contains information that influences future interest rate behaviors, where interest rate is an indicator of economic growth that is commonly used in financial decision making. Economic and market events have effects on interest rates which lead to interest rate changes. Accordingly, configuring an artificial intelligence model that can integrate data from different sources achieves improved artificial intelligence inference.

The modality-aware transformer includes a component used in or as a neural network for processing sequential data. The sequential data in various embodiments includes, but is not limited to, natural language text, genome sequences, sound signals, images, and time-series data. The time-series data may be numerical data. These are examples of data sets having a respectively different modality.

With reference now to FIG. 2, a block diagram (200) is provided to illustrate a general representation of application of the transformer to multiple modalities. As shown, there are two input sources, including a first input source shown herein as a text corpus (210) and a second input source shown as time-series data (220). Data from the first input source (210) is subject to processing by a text module (230) and data from the second input source (220) is subject to processing by a time-series module (240). The text module (230) is configured perform natural language processing on the text corpus (210), for example to disaggregate text based articles into sentences, perform topic modeling, assign individual sentences into one or more topics, compute a sentiment score for each sentence, and/or aggregate sentences' sentiment score at level of topics, forming Xₜₓₜ, etc. The aggregation, Xₜₓₜ, forms the input data stream (246) of the text module (230) to the modality-aware transformer (250). The time-series module (240) is configured to sample the time-series data and learn embedding vectors for each and all components of the time-series, forming Xₜₛ. The learned embedding vector, Xₜₛ, forms the time-series input stream (248) to the modality-aware transformer (250). Accordingly, each input modality (210) and (220), respectively, are subject to initial and separate processing by the text module (230) and the time-series module (240), respectively, to form the multi-modality input to the modality-aware transformer (250).

The multi-modality transformer (250) is shown herein with two separate inputs, (246) and (248), with a first input (246), e.g., Xₜₓₜ, representing textual data and a second input (248), e.g. Xₜₛ, representing time-series data. In an exemplary embodiment, the two inputs (246) and (248) are received and processed by the transformer (250) in parallel. The transformer (250) is configured to conduct feature-level attention, intra-modality attention, and inter-modality attention. Details of the attention layers are shown and described in FIG. 3. Output (260) from the transformer (250) is in the form of future performance of a target series and an explanation of informative topics, including time-series variables that potentially govern behaviors of the target series.

With reference now to FIG. 3, a block diagram (300) is provided to illustrate an artificial intelligence neural network transformer that incorporates multiple data sources from different modalities, hereinafter referred to as a multi-modal transformer. In an exemplary embodiment, the multi-modal transformer (305) is trained with textual data and time-series data, and is further configured to predict a target time-series together with a corresponding explanation. More specifically, the modality-aware structure enables the transformer to exploit inter-modal interactions from one modality to the target in addition to multi-modal interactions between different modalities and the target time-series. As shown and described herein, the transformer includes extended modality attention layers to focus on the most relevant features in each modality. There are two primary components to the multi-modal transformer (305), including an encoder (310) and a decoder (360). The encoder (310) functions to extract features from the input source and generates an attention based representation, and the decoder (360) functions to use the extracted features and generate output.

The multi-modal transformer (305) is configured to receive a multi-modal dataset. In an exemplary embodiment, the first modality and the second modality are different, e.g. the first modality is different from the second modality. In the example shown herein the multi-modal dataset is shown with a first dataset having a first modality, shown herein as textual data, and a second dataset having a second modality, shown herein as time-series data. The first dataset forms a first input sequence and the second dataset forms a second input sequence.

In an embodiment, the two input data sequences may have different lengths. Accordingly, as shown and described below, the transformer is configured to support mismatched data sampling rates, e.g. asynchronous, between the first and second modalities. To address the challenge of datasets with different input sequence lengths, the trained transformer is able to use inputs, at each timestep T, sequences

$$\{ {X}_{T - l b {w}_{ts}}^{ts} , {X}_{T - l b {w}_{t s - 1}}^{ts} , … , {X}_{T - 1}^{ts} \} and \{ {X}_{T - l b {w}_{t x t}}^{txt} , {X}_{T - l b {w}_{t x t - 1}}^{txt} , … , {X}_{T - 1}^{txt} \}$$

where lbwₜₛ and lbwₜₓₜ are different from each other in some embodiments.

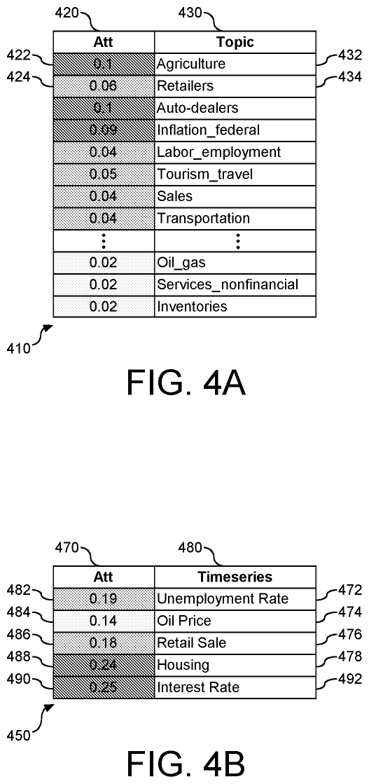

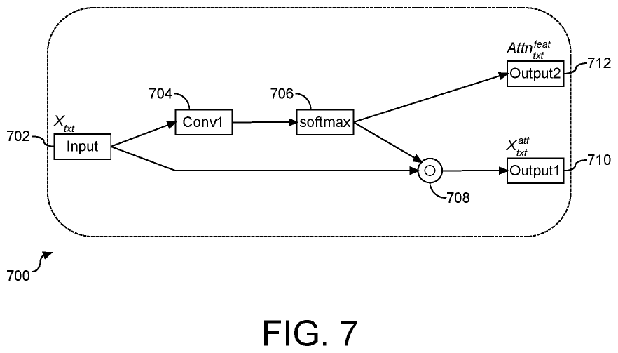

The encoder (310) receives textual input data, Xₜₓₜ, as a first modality input (312_{A}) and time-series data, Xₜₛ, as a second input (312_{B}). Each of the input modalities (312_{A}) and (312_{B}) are processed by an initial layer and subject to separate feature level attention layer mechanisms (314_{A}) and (314_{B}), respectively. Referring to FIG. 7, a block diagram (700) is provided to illustrate the feature level attention layer (314_{A}) of the multi-modal transformer as applied to a textual input sequence and the creation of associated output vectors. As shown, layer (314_{A}) receives the textual input data, Xₜₓₜ, (702) and processes it through a one dimensional convolutional layer (704) and a softmax function (706). The convolutional layer (704) is applied to data, e.g. text sequences. As shown, the convolutional layer (704) receives and processes the textual sequence data. The softmax function (706) is known in the art as a mathematical function that converts a vector of numbers into a vector of probabilities, where the probabilities of each value are proportional to the relative scale of each value in the vector. Two vector outputs, (710) and (712), are shown from the softmax function (706). A first of the output vectors, Xₜₓₜ^{att}, (710) is a product of an element-wise multiplication (708) using the textual input data, Xₜₓₜ, (702) and output from the softmax function (706), and is shown as follows: Xₜₓₜ^{att}=softmax (Conv1(Xₜₓₜ))·Xₜₓₜ. A second of the output vectors, Xₜₓₜ^{feat}, (712) is referred to herein as a text modality feature attention vector. Accordingly, with respect to the textual data, the feature level attention layer (314_{A}) produces the text modality feature attention, Attnₜₓₜ^{feat}, including weighted modality embedded by feature-level attention. In an exemplary embodiment, the attention layer (314_{A}) gives less weight to features, e.g. masks words, which do not contain relevant information. Similarly, for the time-series data, the input at step (702) is time-series data, Xₜₛ, (702) and the feature level attention layer (314_{B}) produces time-series modality feature attention, Attnₜₛ^{feat} at step (712) and output vector Xₜₛ^{att}, (710) where Xₜₛ^{att}=softmax (Conv1(Xₜₛ))·Xₜₛ. An example of the text modality feature attention is shown and described in FIG. 4A, and an example of the time-series modality feature attention is shown in FIG. 4B.

Referring to FIG. 4A, a block diagram (410) is provided to illustrate an example of identified features for the textual input. The block diagram (410) is a matrix representation, with a first column (420) showing the distribution and the second column (430) showing the corresponding topic. In the example shown herein, the topic ‘agriculture’ (432) is shown with a ten percent distribution (422), the topic ‘retailers’ (434) is shown with a six percent distribution (424), etc. In an exemplary embodiment, the total for the distribution of all of the identified topics is one hundred percent. Referring to FIG. 4B, a block diagram (450) is provided to illustrate an example of identified features for the time-series input. The block diagram (450) is a matrix representation, with a first column (470) showing the distribution and the second column (480) showing the corresponding time-series element. In the example shown herein, the unemployment rate (472) is shown with a nineteen percent distribution (482), oil price (474) is shown with a fourteen percent distribution (484), retail sales (476) is shown with an eighteen percent distribution (486), housing (478) is shown with a twenty-four percent distribution (488), and interest rate (492) is shown with a twenty five percent distribution (490), etc. In an exemplary embodiment, the total for the distribution of time-series features is one hundred percent. The distribution values manifest the explainability of the multi-modal aware transformer, as these distribution values indicate which topics and/or time-series the transformer believes are most important for helping predict future time-series values. A higher distribution value indicates that the transformer believes that the respective topic or time-series is more important for the inferencing of the transformer than a lower distribution value is for the inferencing.

Referring to FIG. 3, the feature-level attention layers (314_{A}) and (314_{B}) of the encoder (310) also function to process the corresponding input data feeds and produce three output vectors in the form of keys, K, values, V, and query, Q, for processing by the next layer in the encoder (310). The keys vector, K, is a feature vector that describes when the element might be significant or important. For each input element, there is a values vector, V. The query vector, Q, is a feature vector that describes what is being looked for and should receive attention. With respect to the textual data, the three output vectors are referred to as values, Vₜₓₜ, queries, Qₜₓₜ, and keys, Kₜₓₜ, where:

$${V}_{txt} ∈ {{L}_{{V}_{t x t}} \times {d}_{{v}_{t x t}}}^{} , {Q}_{txt} ∈ {{L}_{{Q}_{t x t}} \times {d}_{{q}_{t x t}}}^{} , and {K}_{txt} ∈ {{L}_{{K}_{t x t}} \times {d}_{{k}_{t x t}}}^{} .$$

L_{V}_{ₜₓₜ}, L_{Q}_{ₜₓₜ} and L_{K}_{ₜₓₜ} denote the lengths of text values, queries, and keys. The text values, queries, and keys have respective dimensions shown herein, as dᵥ_{ₜₓₜ}, d_{q}_{ₜₓₜ}, and dₖ_{ₜₓₜ}. With respect to the time-series data, the three output vectors are referred to as values, Vₜₛ, queries, Qₜₛ, and keys, Kₜₛ, where:

$${V}_{ts} ∈ {{L}_{{V}_{ts}} \times {d}_{{v}_{t s}}}^{} , {Q}_{ts} ∈ {{L}_{{Q}_{t s}} \times {d}_{{q}_{t s}}}^{} , and {K}_{ts} ∈ {{L}_{{K}_{t S}} \times {d}_{{k}_{t s}}}^{} ,$$

and where L_{V}_{ₜₛ}, L_{Q}_{ₜₛ}, and L_{K}_{ₜₛ} denote the lengths of time-series values, queries, and keys. The time-series value, queries, and keys have respective dimensions shown herein as dᵥ_{ₜₛ}, d_{q}_{ₜₛ}, and dₖ_{ₜₛ}.

Each of the text modality keys and the time-series modality keys are separately processed by multiple layers of the encoder (310). In addition, the text modality feature attention, Attnₜₓₜ^{feat}, and the time-series modality feature attention, Attnₜₛ^{feat}, are separately processed through a convolutional layer, shown herein as (340_{A}) and (340_{B}), respectively. In an exemplary embodiment, the one dimensional convolutional layer(s) (340_{A}) and (340_{B}) are applied to data, e.g. text and time-series sequences, respectively. As shown, the convolutional layer (340_{A}) receives and processes the textual modality feature attention, Attnₜₓₜ^{feat}, and the convolutional layer (340_{B}) receives and processes the time-series modality feature attention, Attnₜₛ^{feat}, and as described below provides their output for element-wise multiplication at (332_{A}) and (332_{B}), respectively, with outputs from the normalization layers (330_{A}) and (330_{B}), respectively.

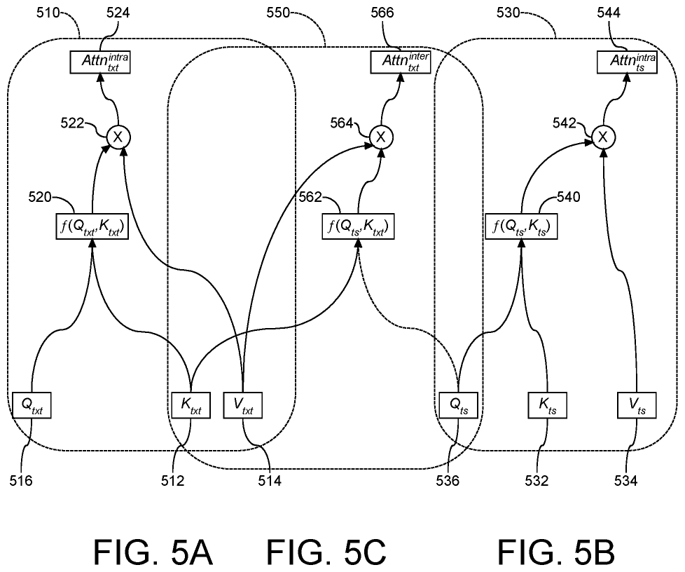

Aside from the convolutional layers (340_{A}) and (340_{B}), the encoder (310) separately subjects the input streams for multi-layer processing. Output from the feature level attention mechanisms (314_{A}) and (314_{B}), respectively, are subject to an intra-modal multi-head attention layer, shown herein as (320_{A}) and (320_{B}), respectively. With respect to the text modality, the input to this layer (320_{A}) includes text modality keys, Kₜₓₜ, text modality values, Vₜₓₜ, and text modality queries, Qₜₓₜ, and output from each attention head in this layer (320_{A}) is a weighted sum of the values, where the weights are determined by intra-modal attention. The output from this layer (320_{A}) is a linear projection of the concatenated multiple heads. Similarly, with respect to the time-series modality, the input to this layer (320_{B}) includes time-series modality keys, Kₜₛ, time-series values, Vₜₛ, and time-series queries, Qₜₛ, and output from this layer (320_{B}) is a linear projection of the concatenated multiple heads, e.g., parallel attention layers. The intra-modal multi-head attention layers (320_{A}) and (320_{B}) are configured to extract the most informative textual data and time steps in each modality, respectively, and are represented mathematically (by way of example referring to the textual modality) as follows:

$$Multi - Head Attention = Concat ( {head}_{1} , … , {head}_{p} ) {W}_{txt}^{o}$$

where p is the number of parallel layers, e.g. heads, in the multi-head attention (320_{A}), Wₜₓₜ^{O} are learnable parameters,

$${head}_{i} = {Attn}_{txt}^{intra} ( {Q}_{txt} {W}_{i}^{Q} , {K}_{txt} {W}_{i}^{K} , {V}_{txt} {W}_{i}^{V} )$$

$$Att {n}_{t x t}^{i n t r a} = softmax ( {Q}_{t x t} {K}_{t x t}^{T} / \sqrt{{d}_{k}} ) {V}_{t x t}$$

$$\begin{matrix}{Q}_{t x t} = A t t {n}_{t x t}^{f e a t} ( {X}_{t x t} ) ∘ {W}_{t x t}^{Q} \\ {K}_{t x t} = A t t {n}_{t x t}^{f e a t} ( {X}_{t x t} ) ∘ {W}_{t x t}^{K} \\ {V}_{t x t} = A t t {n}_{t x t}^{f e a t} ( {X}_{t x t} ) ∘ {W}_{t x t}^{V}\end{matrix}$$

where: dₖ is the keys dimension in a scaling factor of 1/\sqrt{dₖ} and · denotes element-wise multiplication. The Attnₜₓₜ^{intra} and Attnₜₛ^{intra} are generated by applying intra-modal multi-head attentions on encodings of text and time-series modalities, respectively, as shown and described in FIGS. 5A and 5B, respectively. Thus, FIGS. 5A and 5B illustrate, in the abstract, aspects of the multi-head attention layers (320_{A}) and (320_{B}), respectively. Accordingly, the intra-model multi-head attention layers (320_{A}) and (320_{B}), respectively, explore temporal features of the first and second datasets, respectively, and identify one or more first and second temporal features, respectively.

Referring to FIG. 5A, a block diagram (510) is provided to illustrate an abstract generation of the intra-modal attention vector, Attnₜₓₜ^{intra}, for the text based modality. As shown, input includes the text modality keys (512), Kₜₓₜ, text modality values (514), Vₜₓₜ, and text modality queries (516), Qₜₓₜ. The text modality keys (512), Kₜₓₜ, and the text modality queries (516), Qₜₓₜ, are aligned and subject to a softmax function (520), e.g.

$$softmax ( {Q}_{t x t} {K}_{t x t}^{T} / \sqrt{{d}_{k}} ) .$$

The text modality values (514), Vₜₓₜ, are then subject to a matrix multiplication (522) with output from the softmax function (520), with the matrix multiplication forming the intra-model attention vector, Attnₜₓₜ^{intra}, (524). Similarly, referring to FIG. 5B, a block diagram (530) is provided to illustrate an abstract generation of the intra-modal attention vector, Attnₜₛ^{intra}, for the time-series based modality. As shown, input includes the time-series modality keys (532), kₜₛ, time-series modality values (534), Vₜₛ, and time-series modality queries (536), Qₜₛ. The time-series keys (532), Kₜₛ, and the time-series modality queries (536), Qₜₛ, are aligned with the Kₜₛ and subject to a softmax function (540), e.g.

$$softmax ( {Q}_{ts} {K}_{ts}^{T} / \sqrt{{d}_{k}} ) .$$

The time-series modality values (534), Vₜₛ, are then subject to a matrix multiplication (542) with output from the softmax function at (540), with the multiplication output forming the intra-model attention vector, Attnₜₛ^{intra}, (544).

The output from the intra-modal attention layers (320_{A}) and (320_{B}) is subject to normalization. As shown herein, the text modality and the time-series modality are separately subject to normalization at (322_{A}) and (322_{B}), respectively. Addition (shown as the “+” in the formula below) with a value received via a skip connection is performed before the normalization. The following is a mathematical representation of the addition and normalization for the textual modality at (322_{A}):

$${H}_{txt} = LayerNorm ( Intra - modal MHA ( {Attn}_{txt}^{feat} ( {X}_{txt} ) ) + {Attn}_{txt}^{feat} ( {X}_{txt} ) )$$

A similar normalization takes place separately at (322^{B}) for the time-series modality. The following is a mathematical representation of the addition and normalization for the time-series modality at (322_{B}):

$${H}_{ts} = LayerNorm ( Intra - modal MHA ( {Attn}_{ts}^{feat} ( {X}_{ts} ) ) + {Attn}_{ts}^{feat} ( {X}_{ts} ) )$$

Following the normalization at (322_{A}) and (322_{B}), respectively, the one or more first and second temporal features identified in the intra-modal attention layers (320_{A}) and (320_{B}), are subject to inter-modality processing at (324_{A}) and (324_{B}) to discover one or more cross modality relationships. Referring to FIG. 5C, a block diagram (550) is provided to illustrate an abstract generation of the inter-modal attention vector, Attnₜₓₜ^{inter}. Thus, FIG. 5C illustrates, in the abstract, aspects of what occurs within the inter-modality processing layer (324_{A}). A similar process occurs within the inter-modality processing layer (324_{B}) to produce the Attnₜₛ^{inter}. As shown in FIG. 5C, input includes the textual modality keys (512), Kₜₓₜ, and the time-series modality queries (536), Qₜₛ, which are aligned with each other and are subject to a softmax function (562), e.g.

$$soft max ( \frac{{Q}_{ts} {K}_{txt}^{T}}{\sqrt{{d}_{k}}} ) .$$

The text modality values (514), Vₜₓₜ, are then subject to a matrix multiplication at (564) with output from the softmax function (562), with the product of the matrix multiplication (564) forming the inter-modal attention vector, Attnₜₓₜ^{inter}, (566). As shown, the time-series queries vector, Qₜₛ, is applied as input for layer (324^{A}), and text modality queries vector, Qₜₓₜ, is applied as input for layer (324_{B}). Accordingly, the inter-modality processing is configured to discover temporal dependencies between different time steps from the textual and time-series modalities.

The inter-modal processing is represented mathematically by way of example for the textual modality as follows:

$$Inter - modal MHA = Concat ( {head}_{1} , … , {head}_{p} ) {W}_{txt}^{o}$$

$${head}_{i} = {Attn}_{txt}^{inter} ( {Q}_{ts} {W}_{i}^{Q} , {K}_{txt} {W}_{i}^{K} , {V}_{txt} {W}_{i}^{V} )$$

$${Attn}_{txt}^{inter} = soft max ( \frac{{Q}_{ts} {K}_{ts}^{T}}{\sqrt{{d}_{k}}} ) {V}_{txt}$$

As shown, Attnₜₓₜ^{inter} and Attnₜₛ^{inter} are generated by applying inter-modal multi-head attentions on encodings of text and time-series modalities, respectively. The inter-model multi-head attention layer, (324_{A}) and (324_{B}), respectively, are configured to discover one or more cross-relationships between the textual modality and the time-series modality at different lagged orders. For the inter-modal multi-head attention layer (324_{B}), a process (equivalent or similar to process shown in FIG. 5C) is performed but with the Qₜₓₜ and Kₜₛ being aligned and subject to a softmax function. Time-series modality values, Vₜₛ, are then subject to a matrix multiplication with output from the softmax function, with the product of the multiplication forming the inter-modal attention vector, Attnₜₛ^{inter}.

Similar processing is conducted for the time-series modality at layer (324_{B}). Output from each attention head in the inter-modal processing for the textual and time-series modalities is a weighted sum of the values, where the weights are determined by the inter-modal attention. As in the intra-modal attention layer, shown as (320_{A}) and (320_{B}), output from the inter-modal attention layer, shown as (324_{A}) and (324_{B}), is subject to normalization. As shown herein, the text modality and the time-series modality are separately subject to normalization at (326_{A}) and (326_{B}), respectively. Addition (shown as the “+” in the formula below) with a value received via a skip connection is performed before the normalization. The following is a mathematical representation of the addition and normalization at (326_{A}) for the textual modality:

$${H}_{txt}^{′} = LayerNorm ( Inter - modal MHA ( {H}_{txt} ) + {H}_{txt} )$$

and the following is a mathematical representation of the addition and normalization at (326_{B}) for the time-series modality:

$${H}_{ts}^{′} = LayerNorm ( Inter - modal MHA ( {H}_{ts} ) + {H}_{ts} )$$

The next layer in the encoder (310) is shown as a feed forward layer, shown herein as (328_{A}) and (328_{B}), respectively. The feed forward layers (328_{A}) and (328_{B}), respectively, contains weights and processes the output from the normalization layers (326_{A}) and (326_{B}), respectively. In an embodiment, the feed forward layers are applied to the attention vectors to transform the vectors into a form that is acceptable to the next layer. Output from the feed forward layer is subject to normalization. As shown herein, the text modality and the time-series modality are separately subject to addition and normalization at (330_{A}) and (330_{B}), respectively. Addition (shown as the “+” in the formula below) with a value received via a skip connection is performed before the normalization. The following is a mathematical representation of the normalization of the textual modality at (330_{A}):

$$LayerNorm ( FFN ( {H}_{txt}^{′} ) + {H}_{txt}^{′} )$$

and the following is a mathematical representation of the addition and normalization of the textual modality at (330_{A}):

$$LayerNorm ( FFN ( {H}_{ts}^{′} ) + {H}_{ts}^{′} )$$

Output from the normalization layer (330_{A}) is subject to element-wise multiplication at (332_{A}) for the textual input, Attnₜₓₜ^{feat}, from convolutional layer (340_{A}). In an embodiment, the identified feature elements are also referred to herein as an attention layer signal generated from the convolutional layer (340_{A}). Similarly, output from the normalization layer (330_{B}) is subject to element-wise multiplication at (332_{B}) for the time-series input, Attnₜₛ^{feat}, from convolutional layer (340_{B}). In an embodiment, the identified feature elements are also referred to herein as an attention layer signal, from the convolutional layer (340_{B}), respectively. Accordingly, each of the modality-analysis streams of the encoder (310) of the transformer (305) is separately configured to combine an attention layer signal with the one or more discovered cross modality relationships.

The decoder (360) functions to further exploit the dependencies between the target time-series and each data modality, effectively, leading to improvement in forecasting, also referred to as prediction or inference. The decoder (360) includes a stack of two multi-head attention layers with residual connections followed by layer normalization. To prevent each position from attending to subsequent positions, masked multi-head attention is used in the decoder (360). As shown and described below, the structure of the decoder (360) provides flexibility to extract the most informative time steps in each modality, and thereby achieve reliable and stable attention. Input (362), X_{dec}, to the decoder (360) is in the form of raw numeric data from which decoder keys, values, and queries, e.g., Kₜₐᵣ, Vₜₐᵣ, Qₜₐᵣ, respectively, are ascertained and used as input to a masked multi-head attention layer (364). In an exemplary embodiment, ‘tar’ is an abbreviation for the target time-series, and the variables with the subtext ‘tar’ are the inputs to the masked multi-head attention layer (364). Input X_{dec} is a sequence of the target time-series, y, treated as an input sequence to the decoder (360) toward forecasting another target time-series sequence denoted by {y_{(T+1)}, . . . y_{(T+T′)}}. Accordingly, X_{dec}={y_{T} . . . y_{(T+T′-1)}} and is input toward forecasting the output sequence {y_{(T+1)} . . . y_{(T+T′)}}. That means, in forecasting y_{(T+1)}, only X_{dec}=y_{(T)} can be used; likely, in forecasting y_{(T+2)}, only X_{dec}={y_{(T)}, y_{(T+1)}} can be used, etc. For this setting, the ‘masked’ multi-head attention is needed to mask future time points in X_{dec} at each time point. During the inference phase, X_{dec} can be gradually built based on the previously predicted values by the decoder (360).

Thus, during the inference phase X_{dec} (362) represents new time-series information that is different from the time-series data Xₜₛ that was used to help train the transformer (305) during the training phase. The trained transformer is then used to help make predictions about the new time-series information. The trained transformer infers, as mentioned above, gradually and/or in stages in that the trained transformer infers timepoint by timepoint. This gradual inferencing means that in predicting y_{(T+1)} the trained transformer can use data up to y_{(T)} timepoint. In predicting y_{(T+2)} the trained transformer can use data of [y_{(T)}, y_{(T+1)}]. Thus, during the inference phase (362), X_{dec} is formed gradually by using, as input into the decoder (360) for the next time step, predicted values received as output from the decoder (360) from the current or previous time step.

During the training phase, (362) X_{dec} represents the 1-step lagged of the output target time-series sequence. In training, groundtruth y_{(T)} is used to predict y_{(T+1)} and/or groundtruth [y_{(T)}, y_{(T+1)}] is used to predict y_{(T+2)}, etc. During the training time, the groundtruth target time-series, instead of the predicted values, is directly used because the values of the groundtruth target time-series are known.

The masked multi-head attention layer processing is represented mathematically by way of example for the textual modality as follows:

$$Masked MHA = Concat ( {head}_{1} , … , {head}_{p} ) {W}^{o}$$

$${head}_{i} = {Attn}^{masked} ( {Q}_{tar} {W}_{i}^{Q} , {K}_{tar} {W}_{i}^{K} , {V}_{tar} {W}_{i}^{V} )$$

$${Attn}^{masked} = soft max ( \frac{{Q}_{tar} {K}_{tar}^{T}}{\sqrt{{d}_{k}}} ) {V}_{tar}$$

The output from each attention head in the masked multi-head attention layer (364) is in the form of a weighted sum of the values, where the weights are determined by attention.

As shown herein, the output from layer (364) is subject to addition (with values received from a skip connection) and normalization (366), from which a signal is created and utilized as input, Q, to cross-attention layers (368_{A}) and (368_{B}) for both the textual data and the time-series data, respectively. As shown the cross attention layers (368^{A}) and (368_{B}) processes the textual data and the time-series data from the encoder (310) separately. Input to the textual cross attention layer (368_{A}) is in the form of weighted text modality keys by feature level attention, weighted text modality values by feature level attention, and decoder queries. The weighted text modality keys and weighted text modality values (shown in FIG. 3 as Kₜₓₜ and Vₜₓₜ), which are output from the encoder (310), represent the formula:

$${enc}_{{out}_{txt}} = {Attn}_{txt}^{feat} ( {X}_{txt} ) ∘ LayerNorm ( FFN ( {H}_{txt}^{′} ) + {H}_{txt}^{′} )$$

which is the encoder's output weight aggregated from t after applying the feature-level attention. This encₒᵤₜ_{ₜₓₜ} is used as key and value in the decoder (360). Similarly, input to the time-series cross attention layers (368_{B}) is in the form of weighted time-series modality keys by feature level attention, weighted time-series modality values by feature level attention, and decoder queries. The weighted time-series modality keys and weighted time-series modality values, which are output from the encoder (310) and shown in FIG. 3 as Kₜₛ and Vₜₛ, represent the formula:

$${enc}_{{out}_{ts}} = {Attn}_{ts}^{feat} ( {X}_{ts} ) ∘ LayerNorm ( FFN ( {H}_{ts}^{′} ) + {H}_{ts}^{′} )$$

which is the encoder's output weight aggregated from H′ₜₛ after applying the feature-level attention. This encₒᵤₜ_{ₜₛ} is used as key and value in the decoder. Output from each attention head in the textual cross attention layer (368_{A}) is a weighted sum of the values, where the weights are determined by textual target cross attention. Similarly, output from each attention head in the time-series cross attention layer (368_{B}) is a weighted sum of the values, where the weights are determined by time-series target cross attention.

The cross attention layer processing is represented mathematically by way of example for the time-series modality as follows:

$$ts - target Cross - attention = Concat ( {head}_{1} , … , {head}_{p} ) {W}_{tar , ts}^{o}$$

$${head}_{i} = {Attn}_{ts}^{cross} ( {Q}_{tar} {W}_{i}^{Q} , {K}_{tar} {W}_{i}^{K} , {V}_{tar} {W}_{i}^{V} )$$

$${Attn}_{ts}^{cross} = soft max ( \frac{{Q}_{tar} {K}_{ts}^{T}}{\sqrt{{d}_{k}}} ) {V}_{ts}$$

The subscript ‘tar’ denotes the target time-series. The Qₜₐᵣ in the formulas above is shown in FIG. 3 as the “Q” that is output from the addition and normalization layer (366) and is input into layers (368_{A}) and (368_{B}). Similarly, the subscript ‘txt’ denotes the input data sequence, e.g. sample, from the text modality, and the ‘ts’ subscript denotes the input sequence, e.g. sample, from the time-series modality.

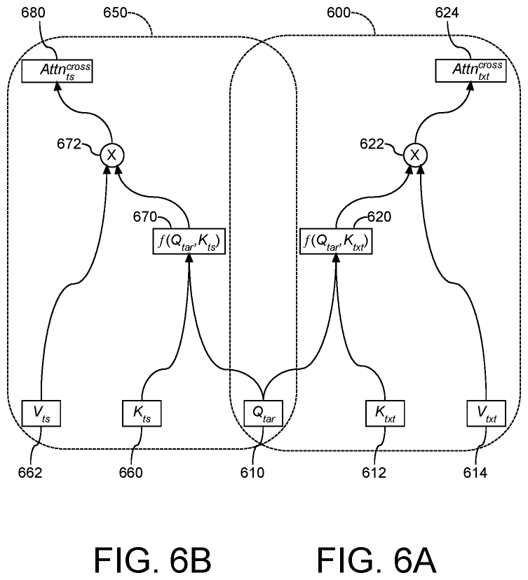

As described above, the cross attention layers (368_{A}) and (368_{B}) each utilize a target cross attention vector for textual data and a target cross attention vector for time-series data. Referring to FIG. 6A, a block diagram (600) is provided to illustrate an abstraction of the target cross attention vector for textual data. As shown, input includes the target queries and keys vectors, Qₜₐᵣ (610) and Kₜₓₜ (612), respectively, which are subject to a softmax function at (620) as follows:

$$soft max ( \frac{{Q}_{tar} {K}_{txt}^{T}}{\sqrt{{d}_{k}}} ) .$$

Output from the softmax function at step (620) is subject to matrix multiplication at (622) with the textual values vector, tₜₓₜ, (614), to form a textual cross attention vector (624), Attnₜₓₜ^{cross}. Referring to FIG. 6B, a block diagram (650) is provided to illustrate an abstraction of the target cross attention vector for time-series data. As shown, input includes the target queries vector and the time-series keys vector, Qₜₐᵣ (610) and Kₜₛ (660), respectively, which are subject to a softmax function at (670) as follows:

$$soft max ( \frac{{Q}_{tar} {K}_{ts}^{T}}{\sqrt{{d}_{k}}} ) .$$

Output from the softmax function (670) is subject to matrix multiplication at (672) with the time-series values vector, Vₜₛ, (662), to form a time-series cross attention vector (680), Attnₜₛ^{cross}. Accordingly, the time-series cross attention vector (680) combines the target query vector with the time-series keys and values vectors.

The textual target cross-attention layer (368_{A}) and the time-series target cross-attention layer (368_{B}) conduct dependencies discovery between the generated target time-series in each modality. Output from the textual target cross-attention layer (368_{A}) and the time-series target cross-attention layer (368_{B}) are combined in (370_{A}) and (370_{B}) with a signal from the addition and normalization (366), and are subject to normalization, shown here as (370_{A}) and (370_{B}), from which a text based signal and a time-series based signal are created. The signals from the normalization layers (370_{A}) and (370_{B}) are combined (372) as input to a feed forward layer (374), followed by addition (with a value received from the skip connection) and normalization (376). Output from the normalization (376) is in the form of a predicted target variable (380) associated with the time-series modality, also referred to herein as time-series forecasting and explanation. In an embodiment, the predicted target variable from time T can be used as input to forecast a target variable at time T+1, etc. Similarly, in an embodiment, the predicted target variables can be used to make future decisions. For example, in the financial domain they can be used to predict interest rate, and from there subject a financial portfolio to an adjustment.

Separate modality encoding streams enable the transformer to generate temporal attentions in each modality stream independently. This structure enables the multi-modal transformer to assign different weights for the same time-step in different modalities to capture informative time-steps of the sequence in each modality. As shown and described above, the multi-modal transformer is configured to receive and process both textual and time-series data, and in an exemplary embodiment with asynchronous rates of data samples, thereby supporting mismatching data sampling rates between modalities. The intra-modal attention described above allows the transformer to attend to the most important time-steps in each modality, and the inter-modal attention enables the transformer to discover the cross-attention correlation between modalities.

Two phases are involved for the multi-modality aware transformer: (1) training and (2) inference. During training, known data of the two different modalities is used to train the multi-modality aware transformer. During the inference phase, the trained multi-modality aware transformer is used to generate inferences about new data sets. The new data sets may have some similarity to the time-series training data or not. In some embodiments, the time-series training data relates to computer usage and the new data set also relates at least partially to computer usage so that the transformer makes inferences about future computer usage. In some embodiments, the time-series training data relates to interest rates and the new data set also relates at least partially to interest rates so that the transformer will make inferences about future interest rates. For the inference phase, the initial data about the new data sets is input directly into the decoder (360). The encoder (310) is still used, however, during inferencing because the encoder (310) provides output into the cross-attention layers (368_{A}) and (368_{B}) as is shown in FIG. 3.

For the training phase, in some embodiments a mean squared error (MSE) is used as a loss function. The parameters of the transformer are updated using a mini-batch of training samples, and the objective function that is implemented may be

$$J ( θ ) = ( \frac{1}{m} ) {\sum }_{k = 1}^{m} {( MSE )}_{k}$$

where m is the batch size and θ are the parameters of the transformer. MSE is the mean squared error between the predicted sequence and the target sequence. The calculated loss is back-propagated through the entire transformer.

In addition, some embodiments include tuning the trained multi-modality aware transformer with additional groundtruth data such as additional groundtruth time-series data.

It is understood that large amount of textual and time-series, e.g. numerical data, are produced in relation to the financial industry. In a first use case, the multi-modal transformer is configured to forecast interest rate from financial text and time-series data. The multi-modal transformer may also be employed in other use cases, including but not limited to stock forecasting, such as adjusted close price, volatility, etc., product sale, disease propagation prediction, inventory management, user action prediction in advertisement applications, etc.

In an exemplary embodiment, a physical hardware device, such as the remote server (104) or the end user device (103), with the identified problem is operatively coupled to the computer (101) with the multiple modality aware artificial neural network transformer (180) across a network connection WAN (102). The predicted target variable (380) generated by the modality-aware transformer (180) identifies a solution or correction to one or more computer hardware components of the physical hardware device such as the remote server (104) and/or the end user device (103). For example, the modality-aware transformer (180) predicts usage of computer memory in order to avoid one or more errors, such as out of memory usage. Memory usage may be automatically adjusted by the system based on the predicted memory usage. For example, the modality-aware transformer (180) may generate a signal associated or aligned with the predicted target variable (380), with the signal causing the system of the physical hardware device or a module within the system of the physical hardware device to allocate memory adapting to that generated signal to accommodate the predicted resource (memory) usage, and in an embodiment making the system run more robustly and optimally. In another example, the modality-aware transformer (180) can be used to predict resource usage demand for successive hours in order to prevent out of memory usage, delays, overprovisioning and under provisioning. Accordingly, the predicted target variable(s) (380) from the modality-aware transformer (180) can dynamically interface with the one or more physical hardware components to dynamically provision one or more physical hardware resources, such as, but not limited to, CPU, GPU, and memory.

In another example, in an embodiment, the predicted target variable (380) may convey a discovery or discover one or more patterns associated with a product and/or an associated product supply chain. The computing environment (100) and particularly the multiple modality aware artificial neural network transformer (180) of the computer (101) is configured to assess the predicted target variable (380) and responsive to the assessment selectively and dynamically generate a control signal. For example, in an embodiment, the control signal selectively controls the operatively coupled physical hardware device such as the remote server (104) or the end user device (103), or in an embodiment a process controlled by software or a combination of the physical hardware device and the software, with the control signal selectively modifying a physical functional aspect of the device. In an embodiment, the device may be a first physical device operatively coupled to an internal component, or in an embodiment a second physical device, and the issued first signal may modify an operating state of the internal component or the second device. For example, the first device may be a product dispenser, and the control signal may modify or control a product dispensing rate to accommodate the rate at which the second device receives the dispensed product. In an embodiment, the computing environment (100) computes a control action based on the predicted target variable (380) generated by the modality-aware transformer (180), and constructs or configures the control signal that aligns or is commensurate with the computed control action. In an exemplary embodiment, the control action may be applied as a feedback signal to directly control an event injection to maximize a likelihood of realizing an event or operating state of the device.

The output, also referred to herein as one or more inferred variables, from the transformer (180) in some embodiments are presented for consumption via a user. In some embodiments, presentation occurs via the generation and display of the one or more inferred variables as an image on a display screen, e.g., on a display screen of the computer (101) shown in FIG. 1. In some embodiments, the presentation includes the generation of a message that includes the one or more inferred variables and the message is transmitted from the computer (101) to another computer such as the end user device (103) and/or the remote server (104) for visual display at a display screen of the other computer. In some embodiments, the presentation may occur via generation of audio that speaks, e.g., presents in audible form, the one or more inferred variables. This audible presentation in some embodiments occurs via an audio speaker of the computer (101) or via an audio speaker of another computer which communicates with the computer (101). In some embodiments, the presentation occurs via printing of the one or more inferred variables onto a physical paper, e.g., via a printer attached to the computer (101).

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
inputting target series data into a transformer comprising an encoder and a decoder, the transformer having been trained on first and second datasets comprising different first and second modalities, respectively, the second dataset comprising time series data, the encoder comprising separate first and second modality streams for analyzing the first and the second datasets, respectively, each of the first and second modality streams respectively performing feature-level attention, intra-modal multi-head attention, and inter-modal multi-head attention, the encoder producing an output using the feature-level attention, the intra-modal multi-head attention, and the inter-modal multi-head attention and sending the output to the decoder; and
in response to the inputting, receiving from the transformer an inferred variable related to the target series data.

2. The computer-implemented method of claim 1, wherein one or more identified first and second temporal features identified by the intra-modal multi-head attentions of the first and second modality streams are input into the respective inter-modal multi-head attention to identify one or more cross modality relationships.

3. The computer-implemented method of claim 2, wherein the identified one or more cross modality relationships and signals from the feature-level attentions are combined to produce the output of the encoder.

4. The computer-implemented method of claim 1, wherein the target series data are input into the decoder, the decoder performs multi-head attention on the target series data, and a signal from the multi-head attention of the decoder is combined with the output from the encoder.

5. The computer-implemented method of claim 4, wherein the output from the encoder comprises a first output signal from the first modality stream and a second output signal from the second modality stream, and wherein the signal from the multi-head attention of the decoder is combined separately with the first output signal and the second output signal for separate analysis of dependencies between:
the target series data and the first dataset and
the target series data and the second dataset.

6. The computer-implemented method of claim 5, wherein the separate analysis of dependencies occurs in a first target cross-attention mechanism and in a second target cross-attention mechanism, and wherein respective outputs from the first and second target cross-attention mechanisms of the decoder are combined to produce the inferred variable related to the target series data.

7. The computer-implemented method of claim 4, wherein the output from the encoder is used as key vector and a value vector for a cross-attention layer in the decoder and a query vector for the cross-attention layer comes from the target series data via the decoder.

8. The computer-implemented method of claim 4, wherein the decoder ascertains keys, values, and queries from the target series data and inputs the keys, the values, and the queries into the multi-head attention.

9. The computer-implemented method of claim 4, wherein the multi-head attention of the decoder is masked-multi-head attention.

10. The computer-implemented method of claim 1, wherein the first dataset comprises time-stamped textual data and the second dataset comprises numerical time series data.

11. The computer-implemented method of claim 9, wherein the feature-level attentions in the first and second modality streams of the encoder generate first weights for the first modality stream and second weights, different from the first weights, for the second modality stream, respectively, based on same time steps from the first and second datasets.

12. The computer-implemented method of claim 9, wherein the time-stamped textual data is produced via performing natural language processing on text articles.

13. The computer-implemented method of claim 1, wherein the intra-modal multi-head attentions extract temporal dependencies between different time steps in a single modality.

14. The computer-implemented method of claim 1, wherein the inter-modal multi-head attentions discover temporal dependencies between different time steps from the first and second datasets.

15. The computer-implemented method of claim 1, wherein the first dataset comprises a first input sequence length, and wherein the second dataset comprises a second input sequence length that is different from the first input sequence length.

16. The computer-implemented method of claim 1, wherein the feature-level attentions in the first and second modality streams of the encoder produce attention matrices providing explainability of the first and second datasets.

17. The computer-implemented method of claim 1, further comprising:
in response to the inputting, receiving from the transformer a series of inferred variables related to the target series data, the series of inferred variables being produced in steps with a further predicted value of the series being based off of an earlier predicted value of the series.

18. The computer-implemented method of claim 1, wherein the inter-modality multi-head attention of the first modality stream uses, as inputs, a keys vector from the first modality stream, a queries vector from the second modality stream, and a values vector from the first modality stream; and
wherein the inter-modality multi-head attention of the second modality stream uses, as inputs, a keys vector from the second modality stream, a queries vector from the first modality stream, and a values vector from the second modality stream.

19. A computer program product comprising:
a computer readable storage medium having program code embodied therewith, the program code executable by a processor to:
input target series data into a transformer comprising an encoder and a decoder, the transformer having been trained on first and second datasets comprising different first and second modalities, respectively, the second dataset comprising time series data, the encoder comprising separate first and second modality streams for analyzing the first and the second datasets, respectively, each of the first and second modality streams respectively performing feature-level attention, intra-modal multi-head attention, and inter-modal multi-head attention, the encoder producing an output using the feature-level attention, the intra-modal multi-head attention, and the inter-modal multi-head attention and sending the output to the decoder; and
in response to the input, receive from the transformer an inferred variable related to the target series data.

20. A computer system comprising:
a processor operatively coupled to memory, and
an artificial intelligence (AI) platform operatively coupled to the processor, the AI platform comprising a transformer and one or more tools configured to interface with the transformer, including:
input target series data into the transformer comprising an encoder and a decoder, the transformer having been trained on first and second datasets comprising different first and second modalities, respectively, the second dataset comprising time series data, the encoder comprising separate first and second modality streams configured to analyze the first and the second datasets, respectively, each of the first and second modality streams respectively configured to perform feature-level attention, intra-modal multi-head attention, and inter-modal multi-head attention, the encoder configured to produce an output using the feature-level attention, the intra-modal multi-head attention, and the inter-modal multi-head attention and send the output to the decoder; and
in response to the input, receive from the transformer an inferred variable related to the target series data.
